(19) United States
(12) Patent Application Publication
(10) Pub. No.: US 2016/0147354 A1
(43) Pub. Date: May 26, 2016

(54) METHOD FOR OPERATING A TOUCH-SENSITIVE OPERATING SYSTEM AND TOUCH-SENSITIVE OPERATING SYSTEM

(71) Applicant: AUDI AG, Ingolstadt (DE)

(72) Inventor: Marcus KUEHNE, Beilngries (DE)

(73) Assignee: AUDI AG, Ingolstadt (DE)

(21) Appl. No.: 14/898,447

(22) PCT Filed: Mar. 31, 2014
(86) PCT No.: PCT/EP2014/000859

§ 371 Date: Dec. 14, 2015

(30) Foreign Application Priority Data
Jun. 13, 2013 (DE) 10 2013 009 906.4

(51) Int. Cl. G06F 3/041; G06F 3/0481; B60K 37/06; G06K 9/00

(52) U.S. Cl. CPC G06F 3/0414; G06K 9/00852; G06K 9/00167; G06F 3/0412; G06F 3/04817; B60K 37/06; B60K 2350/1024; B60K 2350/1052

(57) ABSTRACT

The invention relates to a method for operating a touch-sensitive operator control system (10), particularly for an automobile, in which a pressure exerted with an object (18) on a touch-sensitive control panel (12) and a touch position at which the control panel (12) is touched with the object (18) are sensed, wherein if the sensed pressure is below a prescribed threshold value, the operator control system (10) is operated in a first mode of operation, in which a symbol (20) is displayed at a position on a display device (16) that corresponds to the sensed touch position, and if the sensed pressure is at least as great as the prescribed threshold value, the operator control system (10) is operated in a second mode of operation, in which a character (22) that corresponds to a sensed change in the touch position is displayed by means of the display device (16). Furthermore, the invention relates to a touch-sensitive operator control system (10).

The invention relates to a method for operating a touch-sensitive operator control system and to a touch-sensitive operator control system of the type specified in the preambles of the independent patent claims.

In touch-sensitive operator control systems that are used for handwriting recognition, an essential challenge is for operation of a touch-sensitive control panel, for example with a finger, to allow a the exact position of the touch position on the control panel to be sensed. This is particularly important when inputting complex characters in order to allow the characters to be drawn particularly exactly on the control panel, which assists reliable handwriting recognition, for example.

DE 10 2010 052 983 A1 shows a method for operating a touch-sensitive operator control system. The method disclosed therein involves the sensing of a pressure exerted with a finger on a touch-sensitive control panel and of a touch position at which the control panel is touched with the finger. The method is used to perform handwriting or signature recognition.

US 2004/0012558 A1 shows an apparatus having a touch-sensitive control panel on which a user can draw letters or the like with his finger, for example, the handwriting of the user being recognized by means of a sensing device designed as appropriate for the purpose.

DE 103 04 704 A1 shows a data input unit having a touchpad. The touchpad is mounted in a housing so as to tilt relative to a plurality of pushbutton switches and prestressed in an upper position of rest by means of the pushbutton switches. When a finger pressure on the touchpad is intensified, at least one of the pushbutton switches can be selectively operated.

DE 103 24 579 A1 shows an operator control apparatus for controlling systems in a motor vehicle. The operator control apparatus comprises a touch-sensitive control panel that can be used to make handwritten and graphic inputs for controlling the system.

DE 103 03 793 A1 shows an operator control unit having a touch-sensitive layer for sensing a pressure, wherein the operator control unit has means for tactile feedback when a pressure is exerted.

It is the object of the present invention to provide a method and a touch-sensitive operator control system of the type cited at the outset that can be used for improved character input on a touch-sensitive control panel.

This object is achieved by a method for operating a touch-sensitive operator control system and by a touch-sensitive operator control system having the features of the independent patent claims. Advantageous embodiments with expedient and non-trivial developments of the invention are specified in the dependent claims.

The method according to the invention for operating a touch-sensitive operator control system, particularly for an automobile, involves a pressure exerted with an object on a touch-sensitive control panel and a touch position at which the control panel is touched with the object being sensed. In this case, the method according to the invention is distinguished in that if the sensed pressure is below a prescribed threshold value, the operator control system is operated in a first mode of operation, in which a symbol is displayed at a position on a display device that corresponds to the sensed touch position. If the sensed pressure is at least as great as the prescribed threshold value, the operator control system is operated in a second mode of operation, in which a character that corresponds to the sensed change in the touch position is displayed by means of the display device. Thus, the invention provides for mere touching of the touch-sensitive control panel to prompt first of all just a symbol, for example in the form of a mouse pointer or the like, to be represented and for only the reaching or exceeding of a defined pressure point to prompt a change to an input mode in which appropriate movement of the object over the touch-sensitive control panel draws a corresponding character and displays it by means of the display device. Preferably, the object is a finger of the user of the operator control system. The solution according to the invention ensures that a user exerts sufficient pressure on the touch-sensitive control panel before the second mode of operation is activated, in which a respective character corresponding to a sensed change in the touch position is actually displayed by means of the display device. In this case, the threshold value is preferably chosen to be so great that an application of pressure to the control panel at at least the threshold value involves the assurance of essentially always the same size of contact area for the object, particularly a finger contact area. This ensures particularly exact input of a wide variety of characters by means of the touch-sensitive control panel, since the touch position is sensed under essentially in the same conditions.

In a further advantageous embodiment of the invention, the second mode of operation is changed to the first mode of operation as soon as it is sensed that the pressure exerted with the object on the control panel is again below the prescribed threshold value. This ensures that during operation of the control panel there is constantly sufficient pressure exerted on the control panel by means of the object, that is to say preferably by means of the finger of the user, so that reliable position or character recognition can be ensured.

According to a further advantageous alternative embodiment of the invention, as soon as the operator control system is operated in the second mode of operation the second mode of operation is maintained for as long as an exertion of pressure by means of the object on the control panel is sensed. In other words, it is sufficient to attain the prescribed threshold value once, the operator control system then being operated in the second mode of operation for as long as a pressure is actually exerted on the touch-sensitive control panel with the object. This allows disturbance-free input of characters by a user as soon as he has once reached or exceeded the threshold value by virtue of appropriate operation of the touch-sensitive control panel.

According to a further advantageous embodiment of the invention, the representation of the displayed symbol in the first mode of operation is changed on the basis of a difference between the prescribed threshold value and the sensed pressure. Preferably, the contrast, the color, the brightness, the shape and/or the size of the displayed symbol are changed on the basis of the difference between the prescribed threshold value and the sensed pressure value. A user is thus provided with a visual display of how far away the user is still from the threshold value, which is used as a pressure trigger threshold, before the second mode of operation, which can also be understood as an input mode, is remote. In this case, it is also possible for the sharpness of the represented symbol to be varied by virtue of a combined change of contrast, color, brightness, shape and/or size, so that a kind of substantiation of the displayed symbol is performed as the threshold value is approached to increasing degree.

In a further advantageous embodiment of the invention, an acknowledgement signal is output as soon as the first mode of operation is changed to the second mode of operation. This signals to the user in a simple manner that he has applied the necessary pressure to the control panel and that the second mode of operation, which is used as an input mode, has now been set up.

According to a further advantageous embodiment of the invention, a further acknowledgement signal is output as soon as the second mode of operation is changed to the first mode of operation. This additionally also signals to the user if, by way of example, the pressure he applies to the control panel should no longer be sufficient to maintain the second mode of operation, which is used as an input mode.

In a further advantageous embodiment of the invention, in the second mode of operation the character is evaluated by means of a handwriting recognition device and the corresponding result is displayed by means of the display device. By way of example, in the second mode of operation, an address, a telephone number or the like can be input in handwritten form using handwriting recognition by virtue of appropriate operator control of the touch-sensitive control panel.

The touch-sensitive operator control system, particularly for an automobile, comprises a touch-sensitive control panel that is designed to sense a pressure exerted with an object on the control panel and a touch position at which the control panel is touched with the object. In this case, the operator control system according to the invention is distinguished in that the operator control system comprises a control device that is designed to operate the operator control system in a first mode of operation, in which a symbol is displayed at a position on a display device that corresponds to the sensed touch position, if the sensed pressure is below a prescribed threshold value. In addition, the control device is designed to operate the operator control system in a second mode of operation, in which a character that corresponds to a sensed change in the touch position of the object is displayed by means of the display device, if the sensed pressure is at least as great as the prescribed threshold value. In this case, advantageous embodiments of the method according to the invention can be regarded as advantageous embodiments of the operator control system according to the invention, the operator control system having means for performing the method steps, in particular.

Further advantages, features and details of the invention will become apparent from the description of a preferred exemplary embodiment that follows and from the drawings. The features and combinations of features cited in the description above and also the features and combinations of features that are cited in the description of the figures below and/or that are shown in the figures alone can be used not only in the respectively indicated combination but also in other combinations or on their own without departing from the scope of the invention.

Exemplary embodiments of the invention are explained in more detail below with reference to schematic drawings, in which:

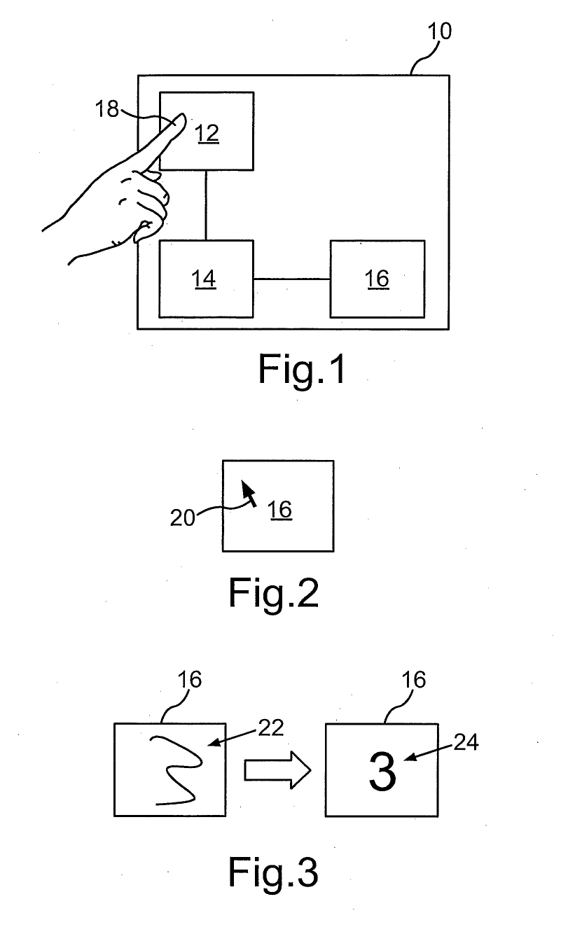

FIG. 1 shows a schematic representation of a touch-sensitive operator control system with a touch-sensitive control panel that is operated using a finger of a user for the purpose of inputting characters;

FIG. 2 shows a schematic representation of a display device of the operator control system, wherein a symbol in the form of an arrow is displayed at a position on a display device that corresponds to the sensed touch position of the finger; and

FIG. 3 shows a character that is represented on the display device and that corresponds to a sensed change in the touch position of the finger, and the same display device, which is used to display a result evaluated by handwriting recognition.

A touch-sensitive operator control system 10 for an automobile is shown in a schematic representation in FIG. 1. The operator control system 10 comprises a touch-sensitive control panel 12, a control device 14 and a display device 16. Furthermore, the touch-sensitive operator control system 10 comprises a handwriting recognition device—not shown here—that can be used to evaluate characters drawn with a finger 18 on the touch-sensitive control panel 12.

The touch-sensitive control panel 12 may be arranged in the region of a central console of an automobile, for example, and be used to make a wide variety of inputs on an entertainment system of the automobile using handwriting recognition. By way of example, appropriate guidance of the finger 18 over the touch-sensitive control panel 12 allows an address for a navigation system, a name for a phone book entry or the like to be input. In this case, the control panel 12 is designed to sense the pressure exerted with the finger 18 on the control panel 12 and also a touch position at which the control panel 12 is touched with the finger 18.

The control device 14 is designed to operate the operator control system 10 in a first mode of operation, in which, as shown schematically in FIG. 2, a symbol 20 is displayed at a position on the display device 16 that corresponds to the sensed touch position, if the pressure exerted with the finger 18 on the control panel, and sensed, is below a prescribed threshold value.

In the case shown in FIG. 2, the symbol 20 is represented as a mouse pointer or as a cursor that is used to represent the positioning of the finger 18 on the control panel 12 as appropriate on the display device 16. The representation of the symbol 20 is changed in the first mode of operation on the basis of a difference between the prescribed threshold value and the sensed pressure. In this case, it is possible for the contrast, the color, the brightness, the shape and/or the size, for example, of the displayed symbol 20 to be changed on the basis of the difference between the prescribed threshold value and the sensed pressure with which a user presses his finger 18 on the control panel 12.

In addition, the control device 14 is designed to operate the operator control system 10 in a second mode of operation, in which a character that corresponds to a sensed change in the touch position of the object 12, as shown schematically in FIG. 3, is displayed by means of the display device 16, if the pressure exerted with the finger 18 on the control panel is at least as great as the prescribed threshold value.

In the case shown in FIG. 3, the user has thus applied or exceeded the prescribed pressure threshold value with his finger 18 when operating the control panel 12, which means that the second mode of operation, which is used as an input mode, has been activated. The user has used his finger 18 to sketch a three, which is shown schematically in the left-hand depiction of FIG. 3. The aforementioned handwriting recognition device is used to evaluate the character 22 that the user has drawn with his finger 18 on the control panel 12 and that is displayed by means of the display device 16, and subsequently the corresponding result 24 is displayed by means of the display device 16, as shown in the right-hand part of FIG. 3.

As soon as it is sensed that the pressure exerted with the finger 18 on the control panel 12 is again below the prescribed threshold value, the second mode of operation, which is used as an input mode, is changed to the first mode of operation again. Should the user thus not continuously exert a pressure with his finger 18 on the control panel 12 that is at least as great as the prescribed threshold value, the symbol 20 is thus in turn displayed by means of the display device 16 in a manner corresponding to the currently sensed positioning of the finger 18 on. In addition, a corresponding acknowledgement signal is output as soon as the second mode of operation is changed to the first mode of operation.

Alternatively, it is also possible that as soon as the operator control system 10 is operated in the second mode of operation, the second mode of operation is maintained for as long as an exertion of pressure by means of the finger 18 on the control panel 12 is sensed. In other words, it is thus only necessary for the user to initially apply a pressure that is as great as the threshold value on the control panel 12 with his finger 18. The operator control system 10 is then operated in the second mode of operation, which is used as an input mode, for as long as he exerts a pressure with his finger 18 on the control panel 12 or touches the control panel 12.

The second mode of operation is changed to the first mode of operation again only as soon as it is sensed that the user has lifted or removed his finger 18 from the control panel 12. When his finger 18 again approaches or is placed on the control panel 12, the operator control system 10 will—provided that the user does not directly exceed the prescribed threshold not with his finger 18—again first of all displayed the symbol 20 corresponding to the sensed position of his finger 18 on the control panel 12 by means of the symbol 20 on the display device 16. As soon as the user presses his finger 18 firmly enough on the control panel 12 in order to reach or exceed the threshold value, the operator control system 10 is operated in the second mode of operation again, in which the user can use his finger 18, by virtue of appropriate operation of the control panel 12, to input a wide variety of characters that are in turn evaluated by means of handwriting recognition.

1-10. (canceled)

11. A method for operating a touch-sensitive operator control system in an automobile, in which a pressure exerted with an object on a touch-sensitive control panel and a touch position at which the control panel is touched with the object are sensed, comprising:
operating the operator control system in a first mode of operation, when a sensed pressure is below a prescribed threshold value, in which a symbol is displayed at a position on a display device that corresponds to a sensed touch position;
operating the operator control system in a second mode of operation, when the sensed pressure is at least as great as the prescribed threshold value, in which a character that corresponds to a change in the touch position is displayed by the display device; and
maintaining operation of the operator control system in the second mode of operation as long as an exertion of pressure by the object on the control panel is sensed.
